(19) United States
(12) Patent Application Publication
(10) Pub. No.: US 2004/0068070 A1
(43) Pub. Date: Apr. 8, 2004

(54) Preparation of readily polymerizable compounds

(75) Inventors: Hans Martan, Frankenthal (DE); Wilhelm Karl Schropp, Weinheim (DE); Gerhard Schulz, Bad Durkheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellcschaft, Ludwigshafen (DE)

(21) Appl. No.: 10/447,225

(22) Filed: May 29, 2003

(30) Foreign Application Priority Data
Jul. 17, 2002 (DE) 10232481.6

(51) Int. Cl. C08F 118/02

(52) U.S. Cl. 526/319; 526/346; 526/317.1; 526/330

(57) ABSTRACT

Process for the preparation of polymerizable compounds, apparatus for this purpose and use of this apparatus.

The present invention relates to a process and an apparatus for the preparation of readily polymerizable compounds.

In order to reduce the polymerization of polymerizable compounds, considerable efforts are made in industrial chemistry to prevent, to avoid or at least to reduce the polymerization.

A shutdown or the failure of a production plant, for example in the case of a pump failure, when the content of pipes is not further transported, is particularly critical since the danger of polymerization of the polymerizable compound present in the pipes increases with increasing residence time. This danger persists in spite of the use of polymerization inhibitors, since the respective stream of polymerization inhibitor present decreases in concentration until the concentration falls below an inhibitor level critical for an incipient polymerization and an undesired polymerization thus occurs.

Pipes are particularly at risk in such a case since they have a relatively large surface compared with the volume of the product contained therein, and polymerization can be induced on this surface. Owing to the relatively small diameter of pipes, they are sensitive, for example, to blockage by fouling.

The use of polymerization inhibitors is widespread. By adding such polymerization inhibitors, the problem of polymerization is as a rule reduced but its cause is not eliminated. There is therefore still a need for novel technical solutions.

EP-A1 1 084 740 describes, as a structural measure, especially on distillation apparatuses, the installation of beveled attachments for, for example, instrument seats, inlet nozzles or manholes, so that condensate of readily polymerizable compounds, in which the concentration of generally poorly volatile polymerization inhibitor has decreased through evaporation and subsequent condensation, can run away more easily, and hence there is no accumulation of unstabilized and consequently readily polymerizable compounds.

The disadvantage of the solution described there is that such attachments have no advantages in the case of a shutdown or production failure.

It is an object of the present invention to provide a process for the preparation of a polymerizable compound, in which the pipes at risk from polymerization are protected by structural measures from blockage due to polymerization during shutdowns.

We have found that this object is achieved by a process for the preparation of polymerizable compounds, in which the pipes carrying a polymerizable stream have a gradient.

The present invention furthermore relates to apparatuses for the preparation of polymerizable compounds, in which those pipes which carry a polymerizable stream have a gradient. The use of plants comprising pipes having a gradient for the preparation of polymerizable compounds is furthermore disclosed.

In this document, pipes are defined as those machines and apparatuses which have a surface area:volume ratio (A/V) of at least 4, preferably at least 8, particularly preferably at least [lacuna], very particularly preferably at least 16, in particular at least 40, m²/m³. These may be, for example, pipelines which have a nominal diameter (ND) of from 100 to 1 000 mm.

A pipeline of 100 mm nominal diameter has, for example, an A/V ratio of about 40 m²/m³, one of 250 mm nominal diameter an A/V ratio of 16 m²/m³ and one of 1 000 mm nominal diameter an AV ratio of 4 m²/m³. The A/V ratio is dependent only on the radius r of the pipe: A/V=2/r.

In this document, containers are defined as those machines and apparatuses which have a smaller surface area:volume ratio than the pipes defined above.

If a container is taken as an ideal cylinder having a circular, flat base and lid, typical A/V ratios are 6 m²/m³ for a radius r of 0.5 m and a height h of 1 m, 4 m²/m³ for r=1 m and h=1 m, 8 m²/m³ for r=0.5 m and h=0.5 m and 2.4 m²/m³ for r=1 m and h=5 m. In general, A/V=(2×h+2×r)/(rxh) for such an ideal cylinder.

The surface area is defined as the surface area on which a polymerization of the polymerizable compound can start. This is, for example, the surface area of an apparatus which comes into contact with the polymerizable compound, for example the inner surface of pipelines.

Volume is defined as the volume which is enclosed by the surface defined above.

What is important according to the invention is that, in a plant for the preparation of polymerizable compounds, those apparatuses which have an unfavorable surface area:volume (A:V) ratio, i.e. 4, preferably at least 8, particularly preferably at least [lacuna], very particularly preferably at least 16, at least in particular at least 40, m²/m³ for a polymerization are designed so that no regions, i.e. pockets, form in which streams which contain polymerizable compounds have long residence times. The residence time without thorough mixing, for example by circulation, stirring or mixing with fresh, product-containing stream, should as a rule be less than 12, preferably less than 8, particularly preferably less than 4, hours.

It is furthermore important for polymerizable compounds in containers to be agitated, for example by stirring, natural circulation or circulation by pumping (forced circulation).

According to the invention, polymerizable compounds are those which have at least one polymerizable bond, for example ethylenically unsaturated double bonds, preferably α,β-unsaturated carbonyl compounds.

Polymerizable compounds are, for example, styrene, vinyl acetate, vinyl propionate, methyl vinyl ether, butyl vinyl ether, 4-hydroxybutyl vinyl ether, allylacetic acid, vinylacetic acid, N-vinylformamide, acrylic acid or methacrylic acid (referred to in this document as (meth)acrylic acid) and preferably (meth)acrylic esters, particularly preferably (meth)acrylic esters of alcohols of 1-4 carbon atoms, very particularly preferably methyl, ethyl, n-butyl, 2-ethylhexyl, 2-hydroxyethyl and 2-dimethylaminoethyl (meth)acrylate, in particular methyl (meth)acrylate and ethyl (meth)acrylate.

Streams which are susceptible to polymerization are as a rule those which have at least 5, preferably at least 10, particularly preferably at least 25, very particularly preferably at least 50, in particular at least 75, especially at least 90, % by weight of the polymerizable compound.

Further possible components of such streams which in turn may be polymerized are starting materials, byproducts, secondary products, intermediates, solvents, polymerization inhibitors and catalysts.

The gradient of the pipes should be such that the content can flow out of the pipe in a period before polymerization occurs. This is dependent on the viscosity of the stream carried through the pipe, so that a person skilled in the art can readily calculate the gradient on the basis of the viscosity or determine such gradient by series of experiments.

As a rule, a gradient of at least 0.5%, i.e. at least 1 cm vertical gradient per 2 m horizontal distance, preferably from 1 to 10%, particularly preferably 1-5%, very particularly preferably 2-5%, in particular 2-4%, is sufficient. A higher gradient is of course also possible but entails a higher required delivery head of the relevant pump.

According to the invention, the direction of the gradient plays no role, the pipe should preferably have an emptying facility at its lowest point and particularly preferably the pipe opens into a container in the direction of the gradient. This should of course be capable of holding the pipe volume to be emptied.

The connection of pipes having a gradient to apparatuses or containers is effected, for example, via beveled attachments which are mounted on the apparatus or on the container at an angle corresponding to the gradient, for example as described in EP-A1 1 084 740, or via angle connectors (elbow fittings) which are bent through the relevant gradient angle relative to the apparatus or the container.

The connection of a pipe having a gradient of, for example, 5° is thus possible via an attachment which is mounted on the apparatus and beveled 5° out of the horizontal or vertical or, if a standard horizontal or vertical connection is present, via an angle connector at an angle of 175°, or 95° or 85°, respectively. Such an angle connector is provided with the connection facilities known per se to a person skilled in the art, for example with flanges.

It is expedient to provide the highest point of the pipes with a shut-off-member, for example a shut-off valve or the like, so that the volume present in the pipe can flow away on both sides. In addition, bleed valves may be mounted at the highest point of the pipes in order to ensure introduction of air into the emptying region for pressure equalization.

In the case of apparatuses on which no gradient for emptying is to be mounted, an emptying facility should preferably be present at the lowest point, via which facility the relevant apparatus can be substantially completely emptied, i.e. can be emptied apart from a residual amount which remains adhering to the wall.

Emptying facilities should be constructed at those points of a production plant and on apparatuses for storage and transport of polymerizable streams in which the stated pockets can form, for example in pipe bends, on discharge pipes, vapor pipes, condensers, heat exchangers, siphons, valves, shut-off valves, pipe segments shut off by shut-off valves, pumps, connecting pieces of measuring instruments, for example for the measurement of pressure, temperature, flow or pH, bleed valves, edges of column trays, etc.

An emptying facility should be mounted in each case at the lowest point so that the region to be emptied empties automatically, preferably into a container, after opening of the emptying facility.

Conceivable emptying facilities are, for example, slide valves or drain valves, e.g. hand valves or electrically, hydraulically or pneumatically actuated valves.

The polymerizable compound can flow through the pipe in liquid, gaseous or mixed liquid/gaseous form.

The gas phase may be either the vapor phase of the polymerizable compound or a gas or gas mixture which is inert under the conditions present, e.g. nitrogen, air, nitrogen/oxygen mixtures, argon, helium, carbon dioxide, carbon monoxide, steam or lower alkanes, preferably air or air/nitrogen mixtures, in particular those having an oxygen content of from 0.1 to 21, preferably from 0.5 to 15, % by volume, very particularly preferably those air/nitrogen mixtures having an oxygen content of from 1 to 10, in particular from 1 to 6, % by volume. In a preferred embodiment, an emptied pipe is flushed with an inert gas or gas mixture, for example through a vent valve, in order to remove the vapor phase present therein.

If the relevant pipe carries exclusively gas phase, in a preferred embodiment the pipe may have trace heating in addition to the gradient, in order to prevent condensation of gas phase, since such a condensate generally has a lower concentration of polymerization inhibitor since typical polymerization inhibitors are sparingly volatile and are therefore not present in a sufficient amount in the gas phase. For this purpose, the pipe is heated by means of trace heating, for example to a temperature which is at least 5° C., preferably at least 10° C., particularly preferably at least 10-30° C., very particularly preferably 10-20° C., above the condensation temperature of the gas phase carried in the pipe at the respective pressure prevailing in the pipe.

Trace heating may be effected, for example, electrically, for example by means of heating tapes or heating collars, or by means of a heat exchanger, for example thermal oil, hot water or steam, in a double jacket or by means of a tube winding.

In a further preferred embodiment, the pipe carrying gaseous polymerizable compound may be sprayed from the inside with a stabilizer, preferably with a stabilizer in a suitable solvent, particularly preferably in the respective polymerizable compound, preferably in addition to the measures described above.

Atmospheric, reduced or superatmospheric pressure may prevail in the pipe to be emptied and, according to the invention, the pressure is not important.

The pressure can, as a rule, range from 20 mbar to 3 bar, preferably from 20 mbar to atmospheric pressure.

If reduced pressure prevails in the pipe, it is of course necessary to ensure pressure equalization for emptying.

The temperature both in the container and in a pipe should in general be kept as low as possible in order to avoid thermally inducing polymerization, but should not be so low that the viscosity is increased and discharge thus becomes more difficult and leads to greater wetting of the pipe walls. The respective temperature depends on the respective polymerizable compound and is above the melting point and below the boiling point at the pressure set in each case.

For example, the temperature in the case of acrylic acid should be not more than 60° C., preferably not more than 40° C., particularly preferably not more than 35° C., very particularly preferably not more than 30° C.

For n-butyl, ethyl or methyl acrylate, the temperature should be not more than 80° C., preferably not more than 60° C., particularly preferably not more than 40° C., very particularly preferably not more than 30° C.

It is preferable if the streams containing polymerizable compound are kept agitated in the containers, for example by stirring or preferably by circulation by means of pumps.

Of course, the polymerizable compound can be stabilized during preparation and/or storage by polymerization inhibitors, for example by phenols, such as alkylphenols, for example o-, m- or p-cresol (methylphenol), 2-tert-butyl-4-methylphenol, 6-tert-butyl-2,4-dimethylphenol, 2,6-di-tert-butyl-4-methylphenol, 2-tert-butylphenol, 4-tert-butylphenol, 2,4-di-tert-butylphenol, 2-methyl-4-tert-butylphenol, 4-tert-butyl-2,6-dimethylphenol or 2,2′-methylenebis(6-tertbutyl-4-methylphenol), 4,4′-oxydiphenyl, hydroquinone, pyrocatechol (1,2-dihydroxybenzene), 2-tert-butyl-6-methylphenol, 2,4,6-tris-tert-butylphenol, 2,6-di-tert-butylphenol, nonylphenol [11066-49-2], octylphenol [140-66-9], 2,6-dimethylphenol, bisphenol A, bisphenol F, bisphenol B, bisphenol C, bisphenol S, 3,3′,5,5′-tetrabromobisphenol A, 2,6-di-tert-butyl-p-cresol, Koresin® from BASF AG, methyl 3,5-di-tert-butyl-4-hydroxybenzoate, 4-tert-butylpyrocatechol, 2-hydroxybenzyl alcohol, 2-methoxy-4-methylphenol, Irganox® 565, 1141, 1192, 1222 and 1425 from Ciba Spezialitatenchemie, aminophenols, e.g. para-aminophenol, nitrosophenols, e.g. para-nitrosophenol and p-nitroso-o-cresol, alkoxyphenols, for example 2-methoxyphenol (guajacol, pyrocatechol monomethyl ether), 2-ethoxyphenol, 2-isopropoxyphenol, 4-methoxyphenol (hydroquinone monomethyl ether), mono- or di-tert-butyl-4-methoxyphenol, 3,5-di-tert-butyl-4-hydroxyanisole, 3-hydroxy-4-methoxybenzyl alcohol, quinones and hydroquinones, e.g. hydroquinone or hydroquinone monomethyl ether, 2,5-di-tert-butylhydroquinone, 2-methyl-p-hydroquinone, 2,3-dimethylhydroquinone, trimethylhydroquinone, 4-methylpyrocatechol, tert-butylhydroquinone, 3-methylpyrocatechol, 4-ethoxyphenol, 4-butoxyphenol, hydroquinone monobenzyl ether, p-phenoxyphenol, 2-methylhydroquinone and 2,5-di-tert-amylhydroquinone, N-oxyls, e.g. 4-hydroxy-2,2,6,6-tetramethylpiperidin-N-oxyl, 4-oxo-2,2,6,6-tetramethylpiperidin-N-oxyl, 4-acetoxy-2,2,6,6tetramethylpiperidin-N-oxyl, 2,2,6,6-tetramethylpiperidin-N-oxyl, 4,4′,4″-tris(2,2,6,6-tetramethylpiperidin-N-oxyl) phosphite, 3-oxo-2,2,5,5-tetramethylpyrrolidin-N-oxyl and 1-oxyl-2,2,6,6-tetramethyl-4-methoxypiperidine, aromatic amines, phenylenediamines, e.g. N,N-diphenylamine, N-nitrosodiphenylamine, nitrosodiethylaniline, N,N′-dialkyl-para-phenylenediamine, it being possible for the alkyl radicals to be identical or different and, in each case independently of one another, to be of 1 to 4 carbon atoms and to be straight-chain or branched, for example N,N′-diisobutyl-p-phenylenediamine, N,N′-diisopropyl-p-phenylenediamine, Irganox 5057 from Ciba Spezialitatenchemie, p-phenylenediamine, N,N′-di-sec-butyl-p-phenylenediamine (Kerobit® BPD from BASF AG), N-phenyl-N′-isopropyl-p-phenylenediamine (Vulkanox® 4010 from Bayer AG), hydroxylamines, e.g. N,N-diethylhydroxylamine, phosphorus-containing compounds, e.g. triphenylphosphine, triphenyl phosphite, hypophosphorous acid or triethyl phosphite, sulfur-containing compounds, e.g. diphenyl sulfide or phenothiazine, or metal salts, e.g. copper or other metal salts, for example copper, manganese, cerium, nickel or chromium chloride, dithiocarbamate, sulfate, salicylate or acetate.

These polymerization inhibitors can be used alone or as a mixture, and it is also possible to use different stabilizers at different points in the preparation process and/or in the storage.

The amount in which the compounds are used in order to have a stabilizing effect on the polymerizable compound is to be determined in conventional experiments.

For example, frequently from 10 to 2 000, preferably from 20 to 1 500, particularly preferably from 50 to 1 000 very particularly preferably from 100 to 750, in particular from 200 to 500, ppm, based on the polymerizable compound, are used.

The polymerization inhibitors may also advantageously be used together with a compound known as a costabilizer, for example an oxygen-containing gas.

Oxygen-containing gases may be, for example, those gases which have an oxygen content of from 0.1 to 50, preferably from 0.5 to 30, particularly preferably from 1 to 20, very particularly preferably from 1 to 10, in particular from 2 to 8, % by volume and are mixed with any desired other gas, for example nitrogen, noble gases, steam, carbon monoxide, carbon dioxide or lower alkanes, air or air/nitrogen mixtures being preferred.

Emptied pipes or apparatuses can, if desired, be flushed, after emptying, with a preferably basic solution and/or water heated, if required, to about 40 to 90° C., in order to remove adhering residues of the polymerizable compound and/or polymer in the pipes or apparatuses. Suitable methods are described, for example, in DE-A1 195 36 179 and in EP-A2 1 033 359. Basic solutions may be, for example, solutions of alkali metal or alkaline earth metal hydroxides, oxides, carbonates or bicarbonates, such as NaOH, KOH, Ca(OH)₂, Na₂CO₃, K₂CO₃, NaHCO₃ or KHCO₃, in water, acetone or alcohols, e.g. methanol, ethanol, n-butanol or ethylene glycol.

The novel process is explained by way of example for the failure of a pump under operating conditions:

The pipes leading to the failed pump and away from it are closed by means of shut-off valves and switched to a pump connected in parallel (B-pump) if present, and the volume of polymerizable compound enclosed in the shut-off pipe is discharged via a drain valve, which is generally mounted at the lowest point in the pump housing. A bleed valve located at the top and intended for venting the pipe (pressure equalization) may be required for this purpose. The volume present in the shut-off pipe is passed through a gradient, leading to the pump and present between the shut-off valves and the pump, to the pump and is discharged there via the drain mentioned. This discharged volume can be discarded, fed into a container or recycled into the working up or preparation of the polymerizable compound. The failed pump can then be removed, for example by disconnection of the flange, and can be replaced.

If no B-pump is present, the relevant pipe is emptied via a gradient leading from the shut-off valve to the nearest container. The content of this nearest container is preferably circulated by means of a pumped circulation. If it is foreseeable that the shutdown will last for a relatively long time, it is advisable to add a further polymerization inhibitor to the container.

A process sequence in which the novel process can be used is described here by way of example for a process for the preparation of acrylic esters, but can of course also be applied to other polymerizable compounds, for example those mentioned above.

The preparation of the crude (meth)acrylic acid which can be used is carried out in a manner known per se, as a rule by heterogeneously catalyzed gas-phase partial oxidation of at least one C₃- or C₄-precursor of (meth)acrylic acid, e.g. propane, propene, acrolein or isobutane, isobutene or methacrolein, with molecular oxygen at elevated temperatures.

For this purpose, in the preparation of the (meth)acrylic acid, the starting gas is as a rule diluted with gases which are inert under the chosen reaction conditions, e.g. nitrogen (N₂), CO₂, saturated C₁-C₆-hydrocarbons and/or steam, and passed, as a mixture with molecular oxygen (O₂) or an oxygen-containing gas, at elevated temperatures (usually from 200 to 450° C.) and, if required, superatmospheric pressure, over solid transition metal mixed oxide catalysts, e.g. containing Mo and V, or Mo, W, Bi and Fe, and converted by oxidation into (meth)acrylic acid. These reactions can be carried out in one or more stages with in each case 1, 2 or more reaction zones and/or catalyst beds which may have a composition and/or reactivity variable from reaction zone to reaction zone. Exemplary processes are described, for example, in DE-A 19 62 431, DE-A 29 43 707, DE-C 12 05 502, EP-A 257 565, EP-A 253 409, DE-A 22 51 364, EP-A 117 146, GB-B 1 450 986 and EP-A 293 224.

Methacrolein can of course also be obtained by aldol condensation of propionaldehyde and formaldehyde and then converted into methacrylic acid, for example as described above.

The acrylic acid-containing product mixture used is preferably obtained from the partial oxidation of propane, propene and/or acrolein.

The resulting hot reaction gas mixture contains a large amount of noncondensable components, such as carbon oxides, nitrogen and oxygen, in addition to the (condensable) acrylic acid and condensable byproducts, e.g. acetic acid, propionic acid, acetone, acrolein, allyl acrylate, the abovementioned lower aldehydes and water.

Numerous methods are known for separating off the acrylic acid from such a reaction gas mixture. Thus, for example in DE-C 21 36 396 or DE-A 24 49 780, the acrylic acid is separated from the reaction gases obtained in the catalytic gas-phase oxidation by countercurrent absorption with a high-boiling hydrophobic solvent. The crude acrylic acid is separated off by distillation from the resulting acrylic acid-containing mixture. Absorption of acrylic acid in high-boiling solvents is also described, for example, in DE-A 2 241 714 and DE-A 43 08 087.

DE-A 2 241 714 describes the use of esters of aliphatic or aromatic mono- or dicarboxylic acids which have a melting point below 30° C. and a boiling point, at atmospheric pressure, above 160° C.

DE-A 43 08 087 recommends the use of a high-boiling mixture of from 0.1 to 25% by weight of ortho-dimethyl phthalate, based on a mixture consisting of from 70 to 75% by weight of diphenyl ether and from 25 to 30% by weight of biphenyl, for separating off acrylic acid from reaction gases of the catalytic oxidation by countercurrent absorption.

The absorption of the reaction gas in water or aqueous acrylic acid solution as an absorbent is also widespread.

The crude acrylic acid is then obtained from the absorbent by separating off by distillation.

The absorbed acrylic acid may also be subjected to a desorption or stripping process after the absorption or before the distillation, in order to reduce the content of aldehydic or other carbonyl-containing byproducts.

It is also possible to subject the reaction mixture from the catalytic gas-phase oxidation for the preparation of acrylic acid to fractional condensation by passing from below into a column comprising internals having separation activity and condensing out the condensable components by cooling, as described, for example, in DE-A 197 40 253, or by an analogous process in which the high boiler fraction is removed via a side take-off, as described in the German Application with the application number 10053086.9.

The crude acrylic acid used is preferably obtained by fractional condensation or by absorption in diphenyl ether/biphenyl/phthalate mixtures.

With regard to the process, the method by which the crude (meth)acrylic acid which can be used has been obtained is unimportant.

The process may consist of the following stages:

1. Pretreatment (optional)

The crude acrylic acid prepared by any desired method and used in the process or another acetic acid- or propionic acid-containing acrylic acid stream may contain, for example, the following components:

| | |
|---|---|
| acrylic acid | 90-99.9% by weight |
| acetic acid | 0.05-3% by weight |
| propionic acid | 0.01-1% by weight |
| diacrylic acid | 0.01-5% by weight |
| water | 0.05-10% by weight |
| 2- or 3-furfural | 0.01-0.1% by weight |
| benzaldehyde | 0.01-0.05% by weight |
| other aldehydes and | 0.01-0.3% by weight |
| other | |
| carbonyl-containing | |
| compounds | |
| inhibitors | 0.01-0.1% by weight |
| maleic acid | 0.001-0.5% by weight |
| (anhydride) | |

Here, aldehydes and carbonyl-containing compounds comprise compounds such as acetone, formaldehyde, acetaldehyde, acrolein or allyl acetate.

With the use of such crude acrylic acid, the latter is advantageously treated, before use in the esterification, in the presence of an amine, of a hydrazine or of a hydrazine derivative, preferably a primary or secondary amine or hydrazine (derivative), particularly preferably a hydrazine, in amounts of 0.5-2, preferably 1-2, particularly preferably 1-1.5 mol/mol of carbonyl-containing impurities, at 20-40° C. for 0.1-10, preferably 0.5-7, particularly preferably from 1 to 5, hours.

An aminophenol, an aminoguanidine or a salt thereof, e.g. aminoguanidine bicarbonate, a carboxylic acid hydrazide, e.g. adipic acid dihydrazide, aniline, monoethanolamine, diethanolamine, hydrazine, hydrazine hydrate, phenylhydrazine, 4-nitrophenylhydrazine or 2,4-dinitrophenylhydrazine is preferably used, particularly preferably hydrazine hydrate.

The reaction is preferably carried out in the presence of 300-3 000 ppm of phenothiazine as a stabilizer, or an equivalent amount of another suitable stabilizer. In order to avoid additional apparatuses, this reaction can be carried out, for example, in a storage tank or a receiver or intermediate container, which is preferably provided with a means of circulation or stirring or a pumped circulation.

Alternatively, the pretreatment can also be carried out in a tubular reactor which, if required, is either heated by means of trace heating, for example via a double jacket, or is thermally insulated after heating in the inlet region, for example by means of heat exchangers.

If the starting acid used is an aldehyde-free acrylic acid-containing fraction obtained in the purification of crude acrylic acid in the preparation of pure acrylic acid and having a carbonyl content of less than 50 ppm, preferably less than 10 ppm, the pretreatment described can be omitted.

It is of course also possible to use a pure acrylic acid for the process, in which case as a rule no pretreatment is carried out.

Such pure acrylic acid may have, for example, the following composition:

| | |
|---|---|
| acrylic acid | 99.7-99.9% by weight |
| acetic acid | 50-1500 ppm by weight |
| propionic acid | 10-500 ppm by weight |
| diacrylic acid | 10-1000 ppm by weight |
| water | 50-1000 ppm by weight |
| aldehydes and other | |
| carbonyl-containing | 1-50 ppm by weight |
| compounds | |
| inhibitors | 100-300 ppm by weight |
| maleic acid (anhydride) | 1-20 ppm by weight |

The alcohol used may contain, for example, the following secondary components: isomeric alcohols (if possible) in amounts of up to 0.5% by weight, ethers of the alcohol used, in amounts of from 10 ppm by weight to 0.1% by weight, corresponding aldehydes of the alcohol used, in amounts of from 10 ppm to 0.2% by weight, corresponding carboxylic acids of the alcohol used, in amounts of from 5 ppm to 0.1% by weight, olefins (if possible) of the alcohol used, formed by elimination of water, in amounts of from 10 ppm to 0.3% by weight, and water in amounts of from 10 ppm by weight to 0.5% by weight.

2. Esterification

The acrylic acid-containing mixture, which may originate from the pretreatment (stage 1), is reacted with the alcohol in a reaction zone (b) in the presence of at least one acidic catalyst.

Suitable acidic catalysts are sulfuric acid, para-toluenesulfonic acid, benzenesulfonic acid, dodecylbenzenesulfonic acid, methanesulfonic acid and mixtures thereof, acidic ion exchangers also being conceivable.

Sulfuric acid, para-toluenesulfonic acid and methanesulfonic acid are preferably used, particularly preferably sulfuric acid.

The catalyst concentration is, for example, 1 to 20, preferably from 5 to 15, % by weight, based on the reaction mixture.

Alcohols suitable for the reaction are those which have 1 to 8, preferably 1 to 4, particularly preferably 1 to 3, carbon atoms.

Methanol, ethanol, n-propanol, isopropanol, n-butanol, isobutanol and 2-ethyhexanol are preferably used, particularly preferably methanol and ethanol.

The alcohol can be fed in in liquid and/or gaseous form. The esterification takes place in at least one heatable reactor b1), thorough mixing being ensured by suitable measures. If a plurality of reactors is used, for example from two to four, they may be arranged in a cascade.

The reaction preferably takes place in one reactor. The reactor b1) is connected to at least one distillation unit which preferably has 30-50 theoretical plates.

The distillation unit b2) is mounted preferably on the reactor b1).

It is also possible to connect a plurality of reactors to a distillation unit. The reflux of the distillation unit is then preferably recycled into the first reactor.

The distillation unit is of a design known per se and has the conventional internals. Suitable column internals are in principle all customary internals, for example trays, stacked packings and/or dumped packings. Among the trays, bubble trays, sieve trays, valve trays, Thormann trays and/or dual-flow trays are preferred, and preferred dumped packings are those comprising rings, coils, saddle elements, Raschig, Intos or Pall rings, barrel or Intalox saddles, Top-Pak, etc., or braids.

The condenser, if present, is of conventional design.

In a preferred embodiment, the bottom region and the evaporator of a distillation unit are used as reactor b1).

If the alcohol is fed in in gaseous form (see below), the preferred metering point is below those internals of the distillation unit b2) which have separation activity or in the circulation.

The reaction mixture is stabilized against undesired polymerization by means of a suitable stabilizer, e.g. phenothiazine (0.05-0.5%, based on the reaction mixture), the stabilizer preferably being fed in with the acrylic acid.

The reaction takes place at 120-150° C. and ambient pressure, but it is also possible to use higher or reduced pressure, ambient pressure being preferred.

The reaction time is as a rule 0.5-10, preferably 1-6, hours.

The starting substances acrylic acid and alcohol are metered in, as a rule, in the stoichiometry 1:0.7-3.0, preferably 1:0.9-2.5, particularly preferably 1:1.0-2.0, in particular 1: 1.0-1.5.

The desired ester formed in the esterification, low boilers, the Michael adducts, among these preferably the alkpxypropionic esters, and the resulting water of reaction are separated off as top product via the column b2) connected to the esterification reactor b1) (top temperature 70-90° C., top pressure 1 bar). The condensed top product (temperature as a rule from 20 to 40° C.) is stabilized with an inhibitor and substantially comprises desired ester, unconverted alcohol, water, acetic acid adduct, Michael adduct, such as alkoxypropionic esters, and various byproducts. The acrylic acid content of the top product is as a rule not more than 0.1%, preferably not more than 0.01%.

Inhibitors used may be the abovementioned ones.

Water-soluble stabilizers are preferred at this point.

The stabilizer is used in amounts of 10-1 000 ppm, preferably from 50 to 500 ppm, based on the distillate.

For further supporting the stabilization, an oxygen-containing gas, preferably air or a mixture of air and nitrogen (lean air), may be present.

This oxygen-containing gas is preferably metered into the bottom region of a column and/or into a circulation evaporator.

Alternatively, it is also possible to dispense with a condensation, in which case the distillate is passed substantially in gaseous form into the downstream scrubbing (stage 3).

The substantially alcohol-free acrylic ester-containing mixture c1) obtained in stage 3 is added as reflux to the uppermost column tray. Preferably 20-80, particularly preferably 30-60, very particularly preferably 40-60, % by weight, based on the reaction mixture, are added as reflux.

A part of the bottom product of the esterification, preferably 0.1-1%, based on desired ester, is separated off continuously as b3) in order to remove high boilers and can either be disposed of, for example incinerated, or fed to a high boiler working-up stage (stage 8).

The esterification is operated in such a way that the bottom product contains not more than 10% of the desired ester and not more than 15% of acrylic acid.

A further process variant comprises carrying out the esterification in a heatable preliminary reactor, under atmospheric or superatmospheric pressure, and feeding the liquid reaction mixture thus obtainable to a distillation unit consisting of column, circulation evaporator and condenser. The reaction mixture is separated as described above. The catalyst-containing bottom product is completely or partially recycled into the reactor.

3. Scrubbing

The distillate or condensate obtained in stage 2 and substantially comprising acrylic esters (75-90%), alcohol (1-10%), water (7-13%), Michael adduct, in particular alkyl alkoxypropionate (0.5-2.5%), acetic esters (0.05-1%) and various low boilers (0.5-3%), e.g. propionic esters, aldehydes and ethers, is subjected to scrubbing with a wash liquid, after addition of further stabilizer if required.

The amount of the wash liquid is 10-200, preferably 40-150, particularly preferably 50-100, % by weight, based on the distillate/condensate.

The wash liquid is, for example, water, to which, if required, basic compounds, for example sodium hydroxide, potassium hydroxide, sodium bicarbonate, sodium carbonate, potassium bicarbonate or potassium carbonate, can also be added, water preferably being used.

The wash liquid used may be tap water, condensate or demineralized water, with or without the above additives.

A further embodiment comprises using or concomitantly using the aqueous phases obtained in the process, for example from phase separators, for example those from stage 4 or 5, or water from vacuum units, e.g. water ring pumps, in particular the aqueous fraction d2) from the alcohol recovery (stage 4).

What is important is that unconverted alcohol from the esterification and other byproducts soluble in the wash liquid are removed by the scrubbing.

In terms of process engineering, all extraction and scrubbing methods and apparatuses known per se can be used for scrubbing in the process described, for example those which are described in Ullmann's Encyclopedia of Industrial Chemistry, 6th ed, 1999 Electronic Release, Chapter: Liquid—Liquid Extraction—Apparatus. These may be, for example, one-stage or multistage, preferably multistage, extractions and those by the cocurrent or countercurrent procedure, preferably the countercurrent procedure.

Sieve tray columns, columns containing stacked or dumped packings, stirred containers or mixer-settler apparatuses, and columns having rotating internals or pulsed columns, are preferably used.

A column having from 70 to 150 theoretical plates is particularly preferably used. Suitable column internals are in principle all conventional internals, for example trays, stacked packings and/or dumped packings. Among the trays, bubble trays, sieve trays, valve trays, Thormann trays and/or dual-flow trays are preferred, and preferred dumped packings are those comprising rings, coils, saddle elements, Raschig, Intos or Pall rings, barrel or Intalox saddles, Top-Pak, etc., or braids.

The distillate/condensate from stage 2 is preferably fed in at the lower end of the column, and the wash liquid preferably at the top.

The organic phase emerging at the top of the column is passed into a separation vessel known per se, in order to separate off residual water as phase c2), and is stabilized with an inhibitor.

The substantially alcohol-free ester phase c1), which as a rule has an alcohol content of not more than 0.1, preferably not more than 0.02, % by weight, is fed partly as reflux to the distillation unit b2) in stage 2 and partly to a further distillative purification of the acrylic ester (stage 5) in a ratio of 30:70-70:30, preferably 40:60-60:40.

The organic phase c1) is worked up by distillation without further scrubbing or neutralizations.

The aqueous phase c2) from the phase separator is preferably fed completely into the alcohol recovery (stage 4).

Here too, the inhibitors used may be the abovementioned ones.

Water-soluble stabilizers are preferred at this point.

The stabilizer is used in amounts of 10-1 000, preferably from 50 to 500, ppm, based on the organic phase emerging at the top of the column.

The aqueous phase c3) which emerges at the lower end of the column and contains in general 5-10% by weight of alcohol, 3-7% by weight of acrylic esters, 0.1-1% by weight of Michael adduct, such as alkyl alkoxypropionate, and 0.1-1% by weight of low boilers, is wholly or partly worked up in stage 4 (alcohol recovery). A part of this aqueous phase c3) may also be recycled as a wash liquid into the scrubbing stage.

A further possibility is not condensing the distillate from stage 2 but feeding it in gaseous form to stage 3 and quenching it with the wash liquid.

In order to reduce the amount of wastewater, it may be expedient wholly or partly to circumvent the scrubbing (stage 3), for example by feeding some or all of the distillate/condensate obtained at the top of the column b2) directly to a working-up by distillation, for example to the low boiler removal (stage 5), it being possible, if required, for a phase separation vessel to be connected upstream for separating off the water formed in the reaction. The bottom product obtained in the working up by distillation, e.g. e3), can, if required, be used partly as reflux for the column b2).

4. Alcohol Recovery

The aqueous phases c2) and c3) obtained in stage 3 are fed, if desired together with the aqueous phase obtained in stage 5 and the aqueous phase obtained in the vacuum generation (water ring pumps), to a stage for the recovery of desired products, i.e. alcohol, acrylic esters and Michael adducts.

The recovery unit preferably consists of a distillation column d) with evaporator and condenser, in each case of conventional design, and a side take-off.

The column preferably has 30-70 theoretical plates, for example trays, stacked packings and/or dumped packings. Among the trays, bubble trays, sieve trays, valve trays, Thormann trays and/or dual-flow trays are preferred, and preferred dumped packings are those comprising rings, coils, saddle elements, Raschig, Intos or Pall rings, barrel or Intalox saddle, Top-Pak, etc., or braids.

The combined aqueous phases are preferably fed in at the upper end of the lower half of the column, the feed being heated to 40-90° C., preferably 60-90° C., preferably by heat exchange with the discharge of the alcohol recovery column.

The bottom temperature is 100-110° C. and the top temperature 60-80° C. at slightly reduced or atmospheric pressure, preferably at atmospheric pressure.

The vapors emerging at the top of the column are condensed, stabilized with an inhibitor and partly fed back as reflux to column d). The remaining part of the condensate d1) is fed directly to the esterification (stage 2). The feed to stage 2, if it is liquid, can be metered roughly in the middle of the column b2), into the reactor b1) or into its feed, or, if it is gaseous, can be metered below the internals having separation activity or into the circulation.

The vapors substantially comprise alcohol (40-70%) and acrylic esters (30-50%).

Here too, the inhibitors used may be the abovementioned ones.

Water-soluble stabilizers are preferred at this point.

The stabilizer is used in amounts of 10-500 ppm, preferably from 50 to 300 ppm, based on the distillate.

An oxygen-containing gas, preferably air or a mixture of air and nitrogen (lean air), may be present for further promoting stabilization.

This oxygen-containing gas is preferably metered into the bottom region of the column and/or into a circulation evaporator.

It is also possible to carry out condensation only partially, preferably the part which is required for the reflux, and to pass the vapors directly into the esterification.

Preferably, a medium boiler fraction d3) in gaseous or liquid form, which mainly contains Michael adducts (5-10% by weight), in particular alkyl alkoxypropionate, alcohol (40-60% by weight) and water, is removed from the column via a side take-off in the lower part of the upper half of the column and is recycled to the reactor b1) of the esterification (stage 2). There, the Michael adducts, in particular alkyl alkoxypropionate, is at least partly cleaved into alcohol and acrylic ester, and alcohol thus liberated is esterified with the acrylic acid present.

The aqueous phase d2) obtained in the bottom of the recovery column d) is cooled in a heat exchanger, preferably by heat transfer to the column feed of d), at least partly recycled into the scrubbing (stage 3) and used there as wash liquid and partly removed, preferably in an amount of 1-50%, particularly preferably 5-40%, in particular from 10 to 30%. The part removed can be disposed of in a manner known per se, for example via a wastewater treatment plant.

A further preferred embodiment comprises adding the fresh alcohol required for the esterification as reflux at the top of the column d) and feeding the vapors directly, preferably in gaseous form, to the reaction zone b) of the esterification (stage 2). The feed is effected as described above.

5. Low Boiler Removal

The low boiler removal is carried out in particular when crude acrylic acid is used as a starting material and/or an acrylic ester having a particularly low content of low boilers is to be prepared.

Some of the substantially alcohol-free acrylic ester mixture (organic phase c1) obtained in the phase separator in stage 3 is separated, in a distillation unit e) consisting of a distillation column, an evaporator and a condenser with phase separation vessel, in each case of conventional design, into a low boiler fraction and a bottom product e3) which contains the desired ester.

The column preferably has 20-60 theoretical plates and the internals described in stage 4.

The feed is preferably present above the middle of the column.

The bottom temperature is from 80 to 100° C. and the column is operated at atmospheric or slightly reduced pressure, for example from 500 mbar to atmospheric pressure, preferably from 700 mbar to atmospheric pressure, particularly preferably from 800 mbar to atmospheric pressure.

The condensed low boiler fraction separates into an aqueous phase e2), which is recycled to the alcohol recovery stage (stage 4) and/or to the scrubbing (stage 3), and into an organic phase e1), which mainly contains alkyl acetate, ether and alkyl acrylate.

The organic phase e1) is mixed with a stabilizer and partly added as reflux to the uppermost column tray of column e) (reflux ratio 20-40) and can be partly fed to a further distillation unit (stage 6).

Inhibitors used here may be the abovementioned ones.

An oxygen-containing gas, preferably air or a mixture of air and nitrogen (lean air), may be present for further promoting the stabilization.

This oxygen-containing gas is preferably metered into the bottom region of the column and/or into a circulation evaporator.

The condenser of stage 5 is preferably fed with a solution of a partly water-soluble inhibitor in the desired ester, preferably by spraying in, in order to prevent polymer formation on the cold surfaces.

6. Working-up of Low Boilers

The working-up of low boilers is carried out in particular when crude acrylic acid is used as a starting material and/or an acrylic ester having a particularly low content of low boilers is to be prepared.

That part of the organic phase e1) of the low boiler fraction from stage 5 which is not used as reflux can be separated in a further distillation unit f) with condenser and phase separation vessel of conventional design, into a low boiler fraction f1), mainly containing alkyl acetate and ether, and into a bottom product f2) substantially comprising alkyl acrylate. The condensate f1) is partly discharged and, for example, thermally utilized or hydrolyzed and, after stabilization analogously to stage 5, is partly fed as reflux with a reflux ratio of, for example, 20-40:1 into the distillation column f).

The discharged fraction may also be subjected to alkaline hydrolysis, for example with sodium hydroxide solution, in order to recover the alcohol contained in the acetate. The hydrolysis discharge can then be fed, for example, to the alcohol recovery d).

The bottom product f2) of the column, which product contains substantially acrylic ester, is recycled to stage 5.

A further possibility is to use the bottom product f2) as reflux in the distillation unit b2) of stage 2.

The bottom temperature is from 60 to 80° C. and the pressure is preferably atmospheric or slightly reduced pressure, for example from 500 mbar to atmospheric pressure, preferably from 700 mbar to atmospheric pressure, particularly preferably from 800 mbar to atmospheric pressure.

A preferred embodiment comprises using a column containing a stacked packing and having preferably 10-30 theoretical plates.

7. Purification by Distillation

The desired ester is isolated as top product g1) from the bottom product e3) which is obtained in stage 5 and has a purity of, as a rule, at least 98%, preferably at least 99%, or, if stages 5 and 6 are not carried out, from the organic phase c1), in a further distillation stage g), in a distillation column having preferably 5-20 theoretical plates and an evaporator and condenser of conventional design, at a bottom temperature of from 40 to 80° C. and a top pressure of 0.1-0.7, preferably 0.2-0.6, bar. The condenser is fed with a solution of a storage stabilizer in the desired ester, the stabilizer solution preferably being sprayed in.

Suitable column internals for the column are in principle all customary internals, for example trays, stacked packings and/or dumped packings. Among the trays, bubble trays, sieve trays, valve trays, Thormann trays and/or dual-flow trays are preferred, and preferred dumped packings are those comprising rings, coils, saddle elements, Raschig, Intos or Pall rings, barrel or Intalox saddles, Top-Pak, etc., or braids.

Inhibitors used here may be the abovementioned ones.

An oxygen-containing gas, preferably air or a mixture of air and nitrogen (lean air), may be present for further promoting the stabilization.

This oxygen-containing gas is preferably metered into the bottom region of the column and/or into a circulation evaporator. Hydroquinone monomethyl ether is preferably used as the storage stabilizer.

The amount is established so that the storage stabilizer content in the condensate is 10-20 ppm.

Inhibitor mixture from stage 5 (see above), preferably 50-100 ppm, is added to a part of the desired ester, and the latter is fed as reflux to the column (reflux ratio 0.1-1:1, preferably 0.1-0.7:1, particularly preferably 0.1-0.5:1).

The bottom product of the column g2), which mainly contains alkyl acrylate and Michael adduct, in particular alkyl alkoxypropionate, is preferably fed to the reactor b1), where, under the esterification conditions, the Michael adducts are at least partly cleaved into alcohol and acrylate.

The acrylic esters obtainable by the process described have a purity of at least 99%, preferably 99.5%, particularly preferably 40 at least 99.8%, in particular at least 99.9%, and contain not more than 1 000 ppm, preferably not more than 500 ppm, of alkyl propionate, not more than 100 ppm, preferably not more than 50 ppm, of alkyl acetate and not more than 100 ppm, preferably not more than 50 ppm, of acrylic acid.

8. Working-up of High Boilers (optional)

At least a part of the stream b3) from the esterification (stage 2) can optionally be subjected to a high boiler cleavage.

For this purpose, the stream b3) and, if required, also the streams d3) and/or g2) containing Michael adducts are fed to a reactor or to a distillation apparatus which may be operated in a circulation and are treated there thermally and/or catalytically.

The temperature in the cleavage is in general from 110 to 220° C., 10 preferably from 120 to 200° C., particularly preferably from 130 to 180° C.

The removal of the remaining acrylic ester and of the resulting cleavage products can be promoted by passing through a gas stream substantially inert under the reaction conditions (stripping), e.g. nitrogen, steam or preferably an oxygen-containing gas, such as air.

The remaining residue can, for example, be partly discharged, distilled or subjected again to the cleavage or used for recovering sulfuric acid.

The gaseous stream which is obtained from the cleavage and may substantially contain acrylic ester, alcohol, acrylic acid and possibly ether and also stabilizer, can, if required after condensation and/or further cooling, be fed preferably into the esterification reactor b1) or below the internals of b2) which have separation activity or into the circulation of reaction zone b).

Instead of this working-up of high boilers, the stream b3) can also advantageously be used for recovering sulfuric acid.

For this purpose, a sulfur-containing stream is converted in a manner known per se into a sulfur oxide-containing stream and reacted, for example in a contact plant, to give sulfuric acid.

We claim:

1. A process for the preparation of polymerizable compounds, wherein the pipes carrying the polymerizable stream have a gradient.

2. A process as claimed in claim 1, wherein the gradient is at least 0.5%.

3. A process as claimed in either of the preceding claims, wherein the polymerizable stream contains at least 5% by weight of the polymerizable compound.

4. A process as claimed in any of the preceding claims, wherein the pipes lead, in the direction of their gradient, into a container or to an apparatus having an emptying facility.

5. A process as claimed in claim 4, wherein the pipes have a ratio of surface area to volume A/V of at least 8 m²/m³.

6. A process as claimed in claim 4, wherein, in the apparatus having an emptying facility, the emptying facility is mounted at the lowest point.

7. A process as claimed in any of the preceding claims, wherein the polymerizable compound is selected from styrene, vinyl acetate, vinyl propionate, methyl vinyl ether, butyl vinyl ether, 4-hydroxybutyl vinyl ether, allylacetic acid, vinylacetic acid, N-vinylformamide, acrylic acid, methacrylic acid and (meth)acrylic esters.

8. A process as claimed in claim 7, wherein the (meth)acrylic ester is selected from methyl (meth)acrylate, ethyl (meth)acrylate, butyl (meth)acrylate and 2-ethylhexyl (meth)acrylate.

9. A plant for the preparation of polymerizable compounds, wherein the pipes carrying a polymerizable stream have a gradient.

10. The use of a plant comprising pipes having a gradient for the preparation of polymerizable compounds.
